(19) United States
(12) Patent Application Publication
(10) Pub. No.: US 2005/0268881 A1
(43) Pub. Date: Dec. 8, 2005

(54) O'Connor/Price rotary engine

(76) Inventor: Michael F. O'Connor, Lincoln, CA (US)

Correspondence Address: Mark C. Jacobs, Esq., 3033 El Camino Avenue, Sacramento, CA, 95821-6014, US

(21) Appl. No.: 11/060,790

(22) Filed: Feb. 18, 2005

Related U.S. Application Data
(60) Provisional application No. 60/546,321, filed on Feb. 23, 2004.

(51) Int. Cl. F02B 53/00

(52) U.S. Cl. 123/245

(57) ABSTRACT

There is disclosed a rotary internal combustion engine, which is a symmetrical engine having three moving parts which are a blocking rotor, the intake compression rotor, and the power exhaust rotor and matching bores in the engine block makes the engine relatively simple to construct, efficient, and reliable due to the lack opposing dynamic forces and few moving parts.

### 1. FIELD OF INVENTION

This invention relates to a rotary internal combustion engine. This engine could be used in any application where other engines are used such as piston, turbine, other rotary designs, even electric motor applications due to its ‘zero start’ capability.

### 2. DESCRIPTION OF PRIOR ART

There are numerous examples of rotary type or non-reciprocating engines. The most well known is probably various versions of the Wankel or Mazda engine. Although this type of design has proven to be a fairly successful rotary engine, it is a somewhat complex engine to machine and has experienced sealing problems that cause it to lose compression and maintain clean burning over the prolonged life of the engine.

### 3. SUMMARY OF INVENTION

This invention is a rotary engine that only requires three main moving parts. The center of the engine is the Blocking Rotor with a portion of it cut-out to act as a valve to allow compressed gases to move from one part of the engine to the other. Tangent to the Blocking Rotor is a Intake/Compression Rotor that utilizes a slat on the rotor to draw in air from the Intake Port and compresses air against the Blocking Rotor at the same time. Also tangent to the Blocking Rotor is a Power/Exhaust Rotor. The Power/Exhaust Rotor is forced to rotate when a fuel/air mixture is ignited and pushes between a slat on the rotor and the Blocking Rotor. At the same time, the advancing edge of the slat forces exhaust gases out of the Exhaust Port. The symmetrical and simple design results in a reliable, efficient, and low cost engine to power a broad range of equipment from: aircraft, cars, boats, tractors, lawn mowers, pumps, power tools, and similar equipment.

### 4. BRIEF DESCRIPTION OF THE DRAWINGS

Drawing 1 shows an exploded view of the engine.

Drawing 2 through 4 shows the engine with two sets of Intake/Compression and Power/Exhaust rotors (ICR-1, PER-1 & ICR-2, PER-2) centered around a single Blocking Rotor (BR) in various phases of operation.

### 5. DETAILED DESCRIPTION OF THE DRAWINGS

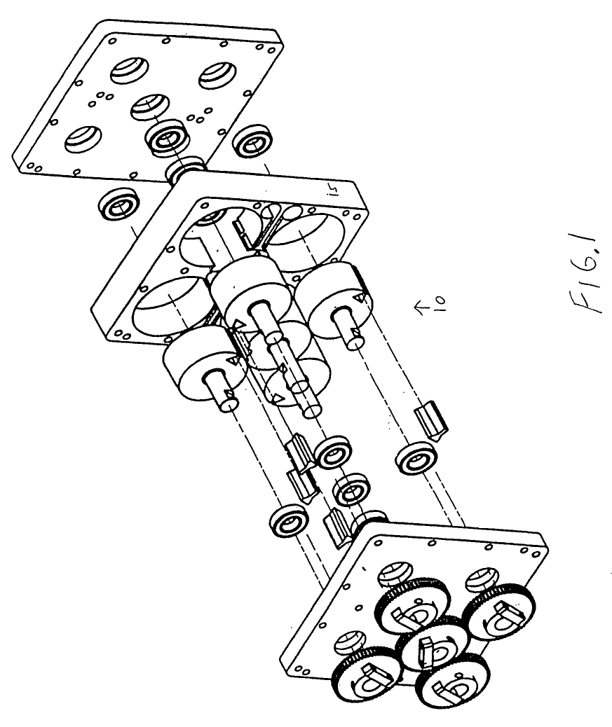

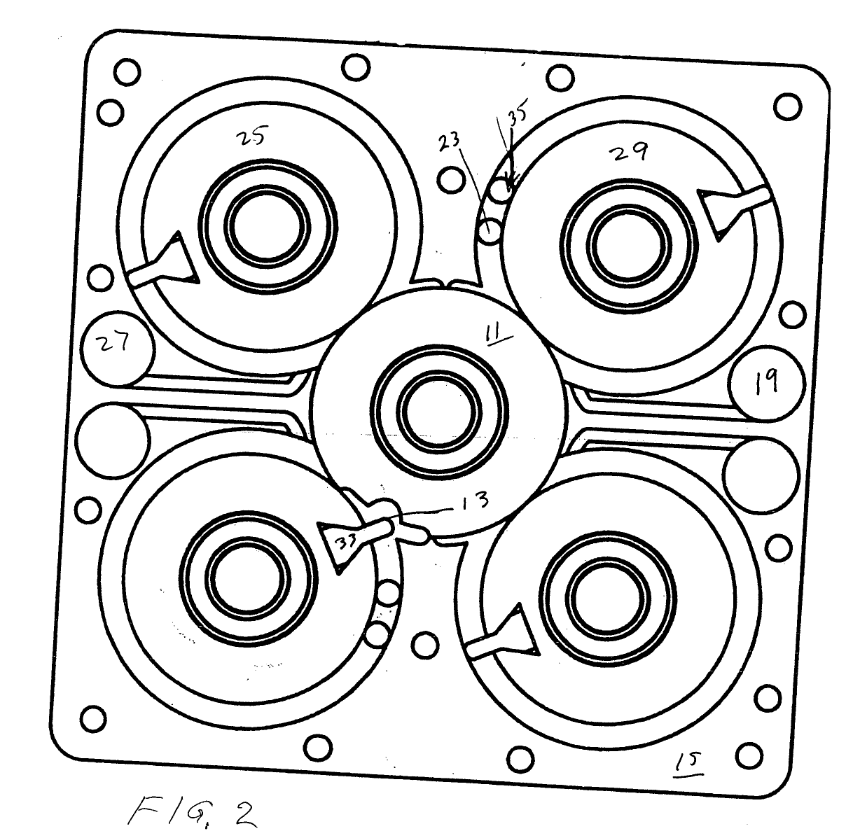

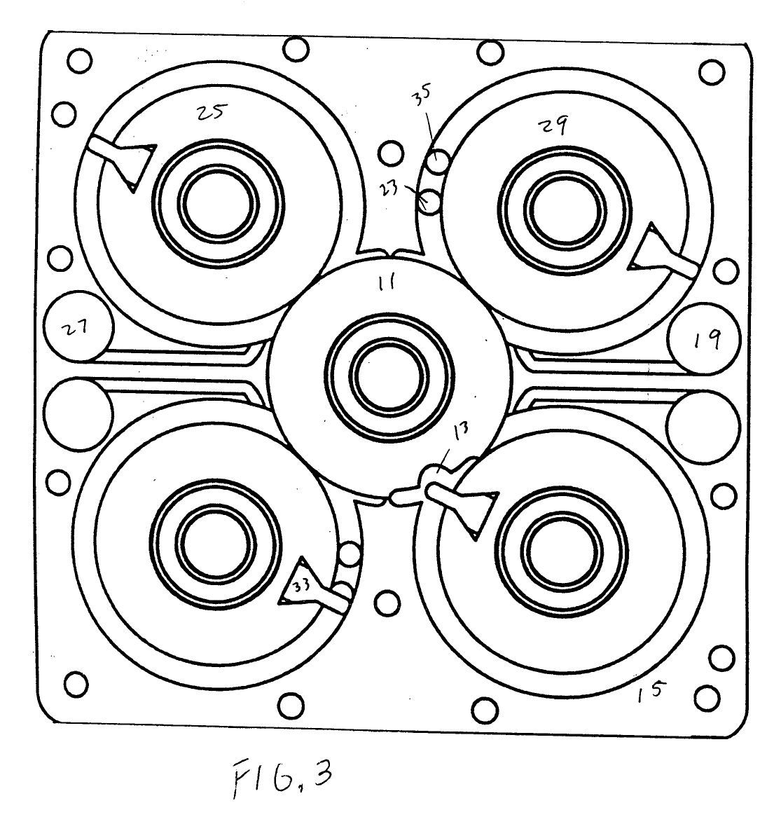

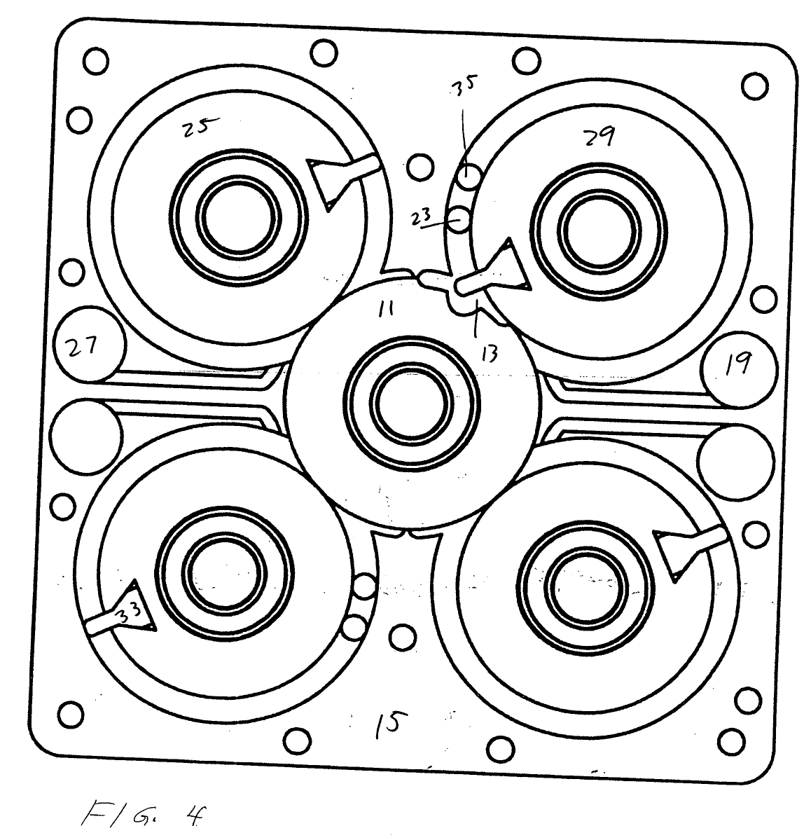

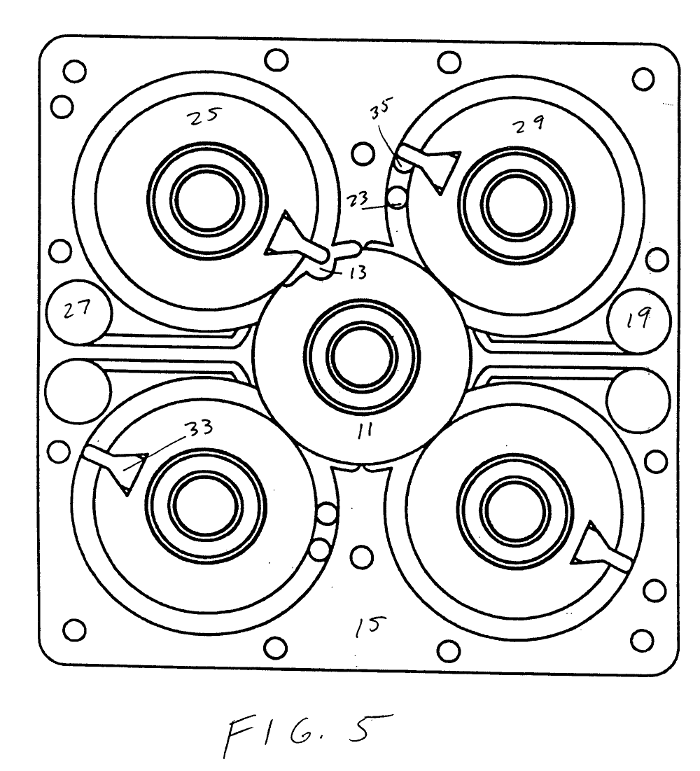

Basically, this engine has three main moving components that are synchronized by a set of gears. FIGS. 1 through 5 shows the O'Connor/Price Engine with two pairs of Intake/Compression and Power/Exhaust rotors rotating around a single Blocking Rotor. In this arrangement there are two Intake/Compression (ICR) Rotors, and two Power/Exhaust Rotors (PER), and the Blocking Rotor (BR) that are synchronized by a set of gears attached to the shaft of each rotor. The ICRs and PERs are symmetrical rotors with at least one removable Rotor Slat (RS) in each rotor. As the protruding RS on the ICRs and PERs rotate in the engine block, they seal against the symmetrical opening in the Engine Block (EB). The symmetrical design of these components is a key factor in the simplicity and effectiveness of this engine.

The operation or cycle of this engine begins when the advancing edge of the Rotor Slat, on the Intake/Compression Rotor (ICR-1), passes the Intake Port (IP-1) and seals against the symmetrical edge of the Engine Block (ref. FIG-A&-B). At this point air (or air and fuel if the engine has a carburetor) is trapped between the advancing edge of the ICR-1/Rotor Slat and the Blocking Rotor. At the same time, the trailing edge of the ICR-1/Rotor Slat is drawing in air from the Intake Port for the next ‘cycle’ of the engine. As the ICR-1 continues to rotate, the advancing edge of the ICR-1/Rotor Slat compresses the trapped air against the Blocking Rotor (ref. FIG-C).

At the point where the air is compressed to the desired pressure, the leading edge of the Blocking Rotor Bypass (BRB), on the Blocking Rotor, clears the Engine Block Barrier (EBB-1) and allows the compressed air to begin transferring to the space created between the retreating edge of the Rotor Slat on the Power/Exhaust Rotor (PER-1), and the Power/Exhaust Rotor and the Blocking Rotor (ref. FIG-D). The compressed air continues to transfer until the trailing edge of the ICR-1/Rotor Slat clears the edge of the Engine Block and simultaneously the trailing edge of the Blocking Rotor Bypass seals against the EBB-1 and traps the compressed fuel and air mixture on the Power/Exhaust side of the engine and is ignited. (ref. FIG-E). Fuel can be added to the compressed air through a carburetor, as mentioned earlier, or by fuel injection.

The ignited gases continue to expand between the trailing edge of the PER-1 Rotor Slat; and the Power/Exhaust and Blocking Rotors; forcing the PER-1 to rotate and produce power. At the same time, the advancing edge of the PER-1/Rotor Slat pushes exhaust gases from the previous cycle out the Exhaust Port (EP-1). The expanding gases continue to produce power until the trailing edge of the PER/Rotor Slat clears the edge of the symmetrical Engine Block and allows the gases to pass through the Exhaust Port (EP-1) (ref. FIG-F).

### 6. DRAWINGS AND PICTURES

Please see attached drawings FIGS. 1 through 5 and pictures FIG A through H.

### 7. Other Attributes and Modifications

There are several attributes that make this engine unique.

a.) Unlike piston engines; there are no pistons, rods, pins, valves, etc. constantly being accelerated and decelerated thousands of times per minute. Along with draining a significant amount of a piston engine's energy, the piston engine design causes extreme wear on the parts and greater likelihood for failure. The Timing Gears (TG) (ref. FIG ?) are the only main points of significant friction in the OPR Engine.

b.) Other Rotary engines such as the Wankel or Mazda require complex machining of the rotor and engine block to prevent significant loss of compression and expanding gases. The the rotors and bores in the engine block on the OPR engine are essentially symmetrical in design which makes machining to close tolerances relatively simple and very cost effective.

c.) Turbine engines are relatively very expensive and generally operate most efficiently at higher rpm's which has limited their use primarily to aircraft and generators. The OPR engine can operate over a wide-range of operating conditions and will be significantly less expensive to manufacture.

d.) The OPR has approximately a 270 degree ‘power stroke’ which will allow for better efficiency of the combusting gases.

e.) The greater expansion of the combusted gases will significantly reduce the exhaust noise.

f.) All components can be readily made from conventional materials an using conventional machining techniques. The simplicity and low wear and stress on the main components will make it feasible to use non-conventional materials and manufacturing techniques such as molded ceramics or even plastics on some components.

g.) The OPR has the potential for being a very reliable engine. Unlike piston engines that can have hundreds of parts that are straining to contain the accelerating and decelerating of pistons from destroying the engine; the OPR engine can be compared to large ‘roller bearings’, synchronized by gears, rolling against each other.

h.) Depending on the application and materials used, the OPR engine has the potential of having a relatively high horsepower to weight ratio.

i.) Due to the approximate 270 degree power cycle, two pairs of Intake/Compression and Power/Exhaust rotors can provide a ‘Zero Start’ capability and eliminate the need for a starter motor. At least one of the two or more Power/Exhaust Rotors will always be in a power phase (or stroke). By injecting fuel into the air trapped between the trailing edge of the slat on the Power/Exhaust Rotor and the Blocking Rotor, and energizing the spark plug, the engine can be started without an electric starter. This ‘Zero Start’ capability could be initiated by simply stepping on the accelerator. This could result in a significant reduction in pollutants caused from idling engines in heavy traffic situations.

1. A rotary internal combustion engine comprised of three synchronized main components all mounted in an engine block, said components being an Intake/Compression Rotor, Blocking Rotor, and Power/Exhaust Rotor tangent to each other.

2. (canceled)

3. The rotary internal combustion engine of claim 1 wherein main body of each rotor is symmetrical, and each main body has a slat inserted into both Intake/Compression rotor and the Power/Exhaust rotor, and wherein the blocking rotor has a cutaway portion to permit the slats to rotate through said blocking rotor.

4. The rotary engine of claim 3 wherein the cutaway portion acts as a bypass to allow the transfer of compressed gases from the Intake/Compression side of the engine to the Power Exhaust side thereof.

5. The apparatus of claim 1 wherein four rotors are present laid out in two aligned columns on the engine block.
